(19) United States
(12) Patent Application Publication
(10) Pub. No.: US 2011/0033624 A1
(43) Pub. Date: Feb. 10, 2011

(54) PROCESS FOR PRODUCING CIGARETTE PAPER HAVING LOW IGNITION PROPENSITY

(76) Inventors: Takeo Tsutsumi, Yokohama-shi (JP); Yukiko Hasegawa, Yokohama-shi (JP)

Correspondence Address: BIRCH STEWART KOLASCH & BIRCH, PO BOX 747, FALLS CHURCH, VA, 22040-0747, US

(21) Appl. No.: 12/909,413

(22) Filed: Oct. 21, 2010

Related U.S. Application Data
(63) Continuation of application No. PCT/JP2009/056183, filed on Mar. 26, 2009.

(30) Foreign Application Priority Data
May 16, 2008 (JP) 2008-129927

(51) Int. Cl. B05D 1/36

(52) U.S. Cl. 427/261; 427/402; 427/419.8

(57) ABSTRACT

A process for producing a cigarette paper exhibiting a low ignition propensity, includes applying a first aqueous solution containing divalent cations to a base wrapping paper on a whole of its one surface, and applying a second aqueous solution containing a water-soluble gellable substance capable of gelling under the action of the divalent cations to at least a part of the surface of the base wrapping paper having the first aqueous solution applied thereto to thereby cause the gellable substance to gel and thus form a combustion-inhibiting substance consisting of the gel.

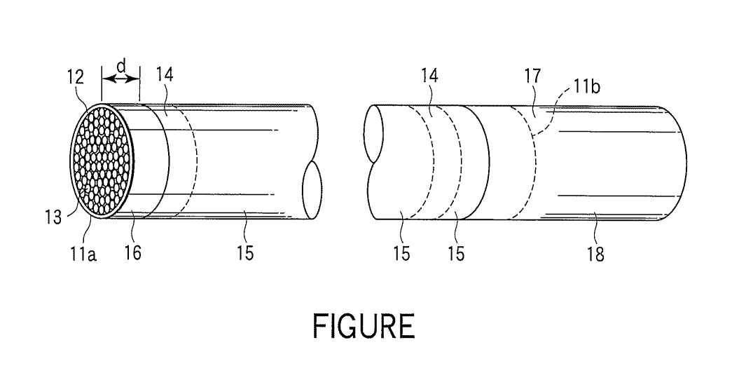

### CROSS REFERENCE TO RELATED APPLICATIONS

This is a Continuation Application of PCT Application No. PCT/JP2009/056183, filed Mar. 26, 2009, which was published under PCT Article 21(2) in Japanese.

This application is based upon and claims the benefit of priority from prior Japanese Patent Application No. 2008-129927, filed May 16, 2008, the entire contents of which are incorporated herein by reference.

### BACKGROUND OF THE INVENTION

1. Field of the Invention

The present invention relates to a process for producing a cigarette paper exhibiting a low ignition propensity.

2. Description of the Related Art

In recent years, various demands have been made of cigarettes. One such demand is, when a cigarette falls on the floor or the like through, for example, the carelessness of the smoker, to lower the propensity of ignition of the floor or the like by the fire source.

For example, Jpn. Pat. Appln. KOKAI Publication No. 7-300795 discloses a process for producing a coated paper (first process) comprising applying a solution of a salt or derivative of alginic acid to cover at least a part of a paper layer containing a particulate material containing polyvalent metal cations, such as calcium carbonate, thereby causing the alginic acid salt or derivative to react with the polyvalent metal cations, forming a polymer coating. Jpn. Pat. Appln. KOKAI Publication No. 7-300795 also discloses a process for producing a coated paper (second process) comprising applying a solution of a salt or derivative of an alginic acid to at least a part of a paper layer and thereafter applying a solution of a material (substance) containing polyvalent metal cations to at least a part of the paper having the solution of an alginic acid salt or derivative applied thereto to thereby cause the alginic acid salt or derivative to react with the polyvalent metal cations, forming a polymer coating. The portion of the paper layer covered with the polymer coating decreases in air permeability, thereby suppressing combustion (constituting a combustion-suppressing area) with the result that the danger of ignition of a flammable substance by burning tobacco can be lowered.

In the above first process of the prior art, the calcium ions generated from the calcium carbonate particles contained in the paper layer in advance are used as a gelling agent, which gels the alginic acid salt or derivative. However, it has been found that only the application of the simple aqueous solution of an alginic acid salt or derivative cannot promote gelation and is not efficient. In fact, in the above first process, it is recommended to acidify the solution of an alginic acid salt or derivative. The reason therefor would be that calcium carbonate can be dissolved in an acidic aqueous solution only. However, using the acidified solution poses the problem of corrosion on application equipment or the like. Further, when the acidified solution is applied to a paper layer (wrapping paper), it is likely for the optical properties of the wrapping paper to suffer an unfavorable influence. Illustratively, the white filler contained in the wrapping paper generally affects the degree of opaqueness and degree of whiteness as optical properties, and an increase in the amount of filler is accompanied by an increase in the values of these optical properties. However, when the acidified solution is applied, calcium carbonate as a white filler would be dissolved therein to thereby invite the danger of lowering of the degree of opaqueness and degree of whiteness, which would degrade the appearance of the wrapping paper. In the second process of the prior art, the application of a solution of an alginic acid salt or derivative to the wrapping paper is followed by the application of a solution of a substance containing polyvalent metal cations. However, the reaction between the alginic acid salt or derivative and the polyvalent metal cations cannot efficiently progress. Further, when the solution of a substance containing polyvalent metal cations is applied by printing, the alginic acid salt or derivative applied in advance would migrate to a printing plate and, by the gel formed by reaction with the polyvalent metal cations, clog the printing plate, thereby causing the continuous application to be difficult.

### BRIEF SUMMARY OF THE INVENTION

Therefore, it is an object of the present invention to provide a process for stably producing a cigarette paper exhibiting a lowered ignition propensity without dissolving the calcium carbonate contained in the wrapping paper by means of an acidified solution.

According to the present invention, there is provided a process for producing a cigarette paper exhibiting a low ignition propensity, comprising applying a first aqueous solution containing divalent cations to a base wrapping paper on a whole of its one surface, and applying a second aqueous solution containing a water-soluble gellable substance capable of gelling under the action of the divalent cations to at least a part of the surface of the base wrapping paper having the first aqueous solution applied thereto to thereby cause the gellable substance to gel and thus form a combustion-inhibiting substance consisting of the gel.

### BRIEF DESCRIPTION OF THE SEVERAL VIEWS OF THE DRAWING

The single FIGURE is a partially broken schematic perspective view showing one form of a cigarette wrapped with a cigarette paper according to one embodiment of the present invention.

### DETAILED DESCRIPTION OF THE INVENTION

In the present invention, first, a first aqueous solution containing divalent cations is applied to a base wrapping paper on the whole of its one surface.

Any of the usual cigarette papers based on the usual pulps, such as flax pulp, can be used as the base wrapping paper. The base wrapping paper can contain any of generally employed fillers, such as a carbonate, for example, calcium carbonate or potassium carbonate and a hydroxide, for example, calcium hydroxide or magnesium hydroxide, in an amount of 2 g/m² or more. The filler can be contained in the base wrapping paper in an amount of 2 to 30 g/m², preferably 2 to 8 g/m². The basis weight of the base wrapping paper is generally 20 g/m² or more, preferably 22 g/m² or more. The basis weight is usually 80 g/m² or less, preferably 65 g/m² or less. The intrinsic air permeability of the base wrapping paper is generally in the range of 10 to 200 Coresta units, preferably 10 to 60 Coresta units.

The base wrapping paper can also be loaded with a combustion-regulating agent, such as citric acid or a salt thereof (sodium salt or potassium salt). Generally, the combustion-regulating agent, when added, is used in the base wrapping paper in an amount of 2% by weight or less. The combustion-regulating agent, when added, is preferably used in the base wrapping paper in an amount of 0.4% by weight or more.

The first aqueous solution containing divalent cations can be obtained by dissolving a water-soluble salt of divalent metal cation in water. Herein, the expression “water-soluble” refers to a salt whose at least 0.7 g can be dissolved in 100 g of water at 25° C. The water-soluble metal salts include both organic metal salts and inorganic metal salts. As examples thereof, there can be mentioned calcium acetate, calcium lactate, calcium gluconate, calcium ascorbate, calcium benzoate, calcium nitrate, calcium chloride, calcium dihydrogen phosphate, magnesium carbonate, magnesium acetate, magnesium lactate, magnesium nitrate, magnesium chloride and the like. Mixtures thereof can also be used. In particular, calcium acetate, calcium lactate and calcium gluconate are preferred.

Subsequently, the second aqueous solution containing a water-soluble gellable substance capable of gelling under the action of the divalent cations is applied to at least a part of the surface of the base wrapping paper having the first aqueous solution applied thereto. The gellable substance is a substance that gels under the action of the divalent cations contained in the first aqueous solution. The mechanism of gelation involves the mechanism in which the cation of sodium, potassium, ammonium or the like contained in the gellable substance is replaced by the divalent cation to thereby form an insoluble product (gel substance) and the mechanism in which a coordinate linkage is formed between the gellable substance and the divalent cation to thereby produce a crosslinked product (gel substance). As examples of the gellable substances, there can be mentioned an alginic salt such as sodium alginate, potassium alginate, ammonium alginate, calcium alginate or magnesium alginate; an alginic ester such as propylene glycol alginate; a pectin (high methoxyl pectin of 50% or higher esterification degree or low methoxyl pectin of below 50% esterification degree); a gellan gum (deacylated gellan gum or native gellan gum); and mixtures thereof. In particular, sodium alginate, a low methoxyl pectin and a deacylated gellan gum are preferred.

The second aqueous solution can be applied to substantially the whole of the surface of the base wrapping paper having the first aqueous solution applied thereto. Alternatively, the second aqueous solution can be selectively applied to a plurality of areas space apart from each other on the surface of the base wrapping paper having the first aqueous solution applied thereto. When the second aqueous solution is selectively applied to a plurality of areas space apart from each other on the surface of the base wrapping paper having the first aqueous solution applied thereto, the plurality of application areas can be those that when a tobacco rod is wrapped with the paper, extend in the longitudinal direction of the tobacco rod and are spaced apart from each other in the circumferential direction of the tobacco rod. Alternatively, the plurality of application areas may preferably be a plurality of circular band areas that when a tobacco rod is wrapped with the paper, extend in the circumferential direction of the tobacco rod and are spaced apart from each other in the longitudinal direction of the tobacco rod.

It is preferred for the gellable substance to be contained in the second aqueous solution in a concentration enough to provide a viscosity appropriate for the method of application to the base wrapping paper. The concentration of the gellable substance can be in the range of 0.1 to 20% by weight, depending on the application method. An appropriate application method is a printing method, especially a gravure printing method. When the second aqueous solution is applied by a gravure printing method, the concentration of the gellable substance is preferably in the range of 0.2 to 10% by weight.

When the second aqueous solution is applied, the first aqueous solution having been applied to the base wrapping paper may be either dried in advance or left in the state of an aqueous solution without being dried. However, it is preferred to apply the second aqueous solution after the application and drying of the first aqueous solution.

When the second aqueous solution is applied to the base wrapping paper having the first aqueous solution applied thereto, as aforementioned, the gellable substance contained in the second aqueous solution interacts with the divalent cations contained in the first aqueous solution to thereby effect gelation. The formed gel substance suppresses the combustion of the paper.

When the second aqueous solution is selectively applied to a plurality of areas spaced apart from each other on the surface of the base wrapping paper having the first aqueous solution applied thereto, the areas of the wrapping paper covered with the gel substance act as combustion-suppressing areas. The areas between mutually neighboring combustion-suppressing areas have the first aqueous solution applied thereto but are not covered with the gel substance, so that the areas can burn substantially equally to the base wrapping paper per se. Namely, the areas between mutually neighboring combustion-suppressing areas can be referred to as ordinary combustion areas.

It is preferred for the divalent cation to be present in the first aqueous solution in an amount sufficient to substantially completely gel the gellable substance. The concentration of the above water-soluble metal salt providing the divalent cations is generally in the range of 0.7 to 40% by weight, preferably 0.7 to 11% by weight.

The gellable substance is preferably applied in an amount of 0.1 to 10 g, more preferably 0.2 to 2 g, per square meter of the base wrapping paper. In this application amount, even when the gellable substance is applied onto the whole surface of the base wrapping paper, the obtained cigarette has such a property that when a burning cigarette is placed on a flammable substance, the burning of the cigarette is extinguished by the action of the gellable substance coupled with the heat absorption by the flammable substance, thereby inhibiting the ignition of the flammable substance. In the application of the same amount of gellable substance, when the gellable substance is selectively applied to a plurality of areas spaced apart from each other on the surface of the base wrapping paper, the amount of gellable substance in each of the application areas is greater than when the gellable substance is applied to substantially the whole surface of the base wrapping paper. More specifically, when the gellable substance is applied to, for example, two spaced-apart 0.2-m² areas within one square meter area of the base wrapping paper, the amount of gellable substance applied to each of these two areas is ((0.1 to 10 g)/(0.2+0.2))/2=0.125 to 12.5 g.

In the present invention, the first aqueous solution can be acidic. However, in the present invention, the first aqueous solution may be alkaline. When the aqueous solution obtained by dissolving a water-soluble metal salt alone in water exhibits acidity, the pH value of the aqueous solution can be adjusted so as to exceed 7 by the addition of a pH adjuster to the aqueous solution. The pH adjuster is preferably one whose aqueous solution exhibits a pH value of 7.5 or higher. The pH adjuster can be an inorganic salt or an organic acid salt. It is preferred for the inorganic salt and organic acid salt to be salts of a monovalent cation. As examples of such salts, there can be mentioned an inorganic salt such as sodium hydroxide or potassium hydroxide, sodium acetate, potassium acetate, trisodium citrate, tripotassium citrate, sodium lactate, potassium lactate, sodium ascorbate, potassium ascorbate, sodium benzoate, potassium benzoate and the like. Mixtures thereof can also be used. In particular, potassium hydroxide, trisodium citrate and tripotassium citrate are preferred. These pH adjusters are preferably added to the first aqueous solution in an amount of less than 6% by weight. These pH adjusters are preferably added to the first aqueous solution in an amount of 0.001% by weight or greater.

As aforementioned, in the present invention, the first aqueous solution containing divalent cations is applied to the whole surface of the base wrapping paper, and thereafter the aqueous solution of a gellable substance is applied thereto. Therefore, as compared with the instance in which the gellable substance is first applied to the base wrapping paper and thereafter the divalent cations are applied, the gelation reaction progresses fast and satisfactorily to thereby ensure high efficiency. Further, a gel substance can be formed without being influenced by the pH value of the solution. Still further, there is no problem of clogging of a printing plate by a gel as experienced when the gellable substance is first applied to the base wrapping paper and thereafter the divalent cations are applied. Moreover, when the gellable substance is first applied to interspaced areas of the base wrapping paper and thereafter the divalent cations are applied, the periphery of application areas may not be clearly defined because of exudation. In the present invention, such a phenomenon can be avoided, and the periphery of application areas can be clearly defined.

The cigarette paper exhibiting a low ignition propensity according to the present invention is used to wrap a tobacco rod composed of tobacco fillers, such as cut tobacco. Generally, the surface having the gel substance applied thereto is brought into contact with the tobacco rod.

FIGURE shows a cigarette 10 wrapped with a cigarette paper in which the combustion-inhibiting substance (gel substance) is applied thereto so as to form circular bands when the cigarette is wrapped with the cigarette paper.

Next, the present invention will further be described with reference to the appended drawing.

FIGURE shows a cigarette 10 wrapped with a cigarette paper in which the gel substance is applied thereto so as to form circular bands when the cigarette is wrapped with the cigarette paper.

Referring to FIGURE, the cigarette 10 comprises a tobacco rod 11 formed of a tobacco filler 13 wrapped with a wrapping paper 12 into a columnar form. The tobacco rod 11 generally has a circumferential length of 17 to 26 mm and a longitudinal length of 49 to 90 mm. An ordinary filter 18 can be fitted to the proximal end 11b (namely, downstream end in the direction of suction) of the tobacco rod 11 by a conventional method using a tipping paper 17.

The base wrapping paper 12 is provided with a plurality of circular-band areas 14 having the combustion-inhibiting substance applied thereto, which establish combustion-inhibiting areas. These circular-band combustion-inhibiting areas 14 are formed with spaces therebetween in the longitudinal direction of the tobacco rod.

Ordinary combustion areas 15 having no combustion-inhibiting substance applied thereto are established between mutually neighboring circular-band combustion-inhibiting areas 14. For example, two or three circular-band combustion-inhibiting areas 14 can be provided. Each of the circular-band combustion-inhibiting areas 14 can have a width of 4 to 7 mm in the longitudinal direction. It is preferred for the spacing between mutually neighboring circular-band combustion-inhibiting areas 14 to be in the range of 18 to 25 mm.

In the cigarette shown in FIGURE, no combustion-inhibiting substance is applied to an area 16 ranging from the distal end thereof to a distance d. This distal-end portion having no combustion-inhibiting substance applied thereto also constitutes an ordinary combustion area 16, which can correspond to an area combusted by one or two puffs of a usual cigarette. The distance d can be in the range of 10 to 25 mm from the distal end 11a of the tobacco rod. It is not particularly needed to provide a combustion-inhibiting areas 14 on the internal surface of the wrapping paper corresponding to the portion of the wrapping paper 12 covered by a tipping paper 17.

When the cigarette 10 is ignited at the distal end 11a of the cigarette rod 11 and combusted by taking a draught, the ordinary combustion areas 15 can burn in the same manner as ordinary cigarettes, so that the smoker can enjoy smoking taste. However, when the cigarette 10 while burning is placed on a flammable substance, such as a carpet, a tatami mat, a wooden product, cloth or clothes, the burning of the cigarette 10 is extinguished by the action of the combustion-inhibiting areas 14 lying in the direction of combustion coupled with the heat absorption by the flammable substance, thereby inhibiting the ignition of the flammable substance.

An embodiment wherein the second aqueous solution is applied to substantially the whole surface of the base wrapping paper would be easily understood without reference to any drawing. Even when the second aqueous solution is applied to substantially the whole surface of the base wrapping paper, the application of the second aqueous solution can be skipped at the portion corresponding to the area 16 in the same manner as in the cigarette of FIGURE. The expression “applying the second aqueous solution to substantially the whole surface of the base wrapping paper” involves this embodiment.

The present invention will be described below with reference to Examples, which in no way limit the scope of the present invention.

### Examples 1 to 7 and Comparative Examples 1 to 7

Each of the first aqueous solutions shown in Table 1 below (aqueous solution of calcium lactate prepared from commercially available calcium lactate pentahydrate [a commercially available citric salt was added to the aqueous solution of calcium lactate in a concentration of 0.5% by weight as a pH adjuster]) was applied entirely to one surface of a base wrapping paper (width: 27 mm; length: 1.500 m) with an intrinsic air permeability of about 35 Coresta units, the base wrapping paper containing about 67% by weight of pulp, about 32% by weight of calcium carbonate (filler) and about 1% by weight of sodium citrate (combustion-regulating agent). Thereafter, a second aqueous solution (aqueous solution of sodium alginate IL-2 produced by KIMICA Corporation [concentration: 0.5 to 7% by weight]) indicated in Table 1 was applied (printed) to the above one surface according to a direct gravure method. The application could be performed without any problem. With respect to the thus obtained cigarette papers, the total amount of sodium alginate applied was measured by the method to be described hereinafter, and the air permeability was measured by the ordinary method.

Using each of the obtained cigarette papers, American blend cut tobacco (amount of tar when no filter is attached: 19 to 20 mg/cigarette) were wrapped therewith into a rod form. The length per cigarette was 59 mm. With respect to the obtained cigarettes, a fire spread test of 20 cigarettes of the same specifications was carried out on ten filter papers piled one upon another in accordance with ASTM E-2187-04. The percentage of full-length burn (PFLB) values thereof were measured, and averages were calculated. The results are also given in Table 1.

TABLE 1

| | | | | | | | Properties | |
|---|---|---|---|---|---|---|---|---|
| | First aqueous solution | | | Second aqueous solution | | | Air permea- | |
| | Calcium lactate | | | Sodium alginate (IL-2) | | | bility of | |
| | Aq. soln. | | Appln. amt. | Aq. soln. | | Appln. amt. | cigarette | |
| | conc. | pH of aq. | per paper | conc. | pH of aq. | per paper | paper | PFLB |
| | (wt. %) | soln. | (g/m²) | (wt. %) | soln. | (g/m²) | (C.U.) | (%) |
| Comp. Ex. 1 | none | — | — | none | — | — | 35 | 100 |
| (base | | | | | | | | |
| wrapping | | | | | | | | |
| paper) | | | | | | | | |
| Comp. Ex. 2 | none | — | — | 0.5 | 7.4 | 0.21 | 33 | 100 |
| Comp. Ex. 3 | none | — | — | 0.8 | 7.2 | 0.39 | 31 | 80 |
| Comp. Ex. 4 | none | — | — | 1 | 7.1 | 0.44 | 30 | 95 |
| Comp. Ex. 5 | none | — | — | 3 | 7.0 | 1.58 | 16 | 60 |
| Comp. Ex. 6 | none | — | — | 5 | 6.8 | 2.69 | 4 | 0 |
| Comp. Ex. 7 | none | — | — | 7 | 6.8 | 3.08 | 2 | 0 |
| Example 1 | 3.5 | 7.2 | 0.99 | 0.5 | 7.4 | 0.22 | 3 | 0 |
| Example 2 | 3.5 | 7.2 | 0.99 | 0.8 | 7.2 | 0.49 | 0 | 0 |
| Example 3 | 3.5 | 7.2 | 0.99 | 1 | 7.1 | 0.55 | 0 | 0 |
| Example 4 | 2.1 | 7.2 | 0.58 | 0.5 | 7.4 | 0.23 | 8 | 35 |
| Example 5 | 2.1 | 7.2 | 0.58 | 0.8 | 7.2 | 0.42 | 2 | 0 |
| Example 6 | 2.1 | 7.2 | 0.58 | 1 | 7.1 | 0.57 | 1 | 0 |
| Example 7 | 0.7 | 7.2 | 0.21 | 3 | 7.0 | 1.95 | 8 | 0 |

It is apparent from the results of Table 1 that the cigarette papers produced according to the present invention, even with the application of a small amount of unacidified gellable substance, can stably exhibit a low ignition propensity.

### Examples 8 to 11 and Comparative Examples 8 and 9

Each of the first aqueous solutions shown in Table 2 below (aqueous solution of calcium acetate prepared from commercially available calcium acetate monohydrate or an aqueous solution of calcium lactate prepared from commercially available calcium lactate pentahydrate [as a pH adjuster, a commercially available citric salt at a concentration of 0.5% by weight or commercially available potassium hydroxide at a concentration of 0.001% by weight was added to the aqueous solution of calcium lactate]) was applied entirely to one surface of the same base wrapping paper as used in Examples 1 to 7 and Comparative Examples 1 to 7. Thereafter, a second aqueous solution (aqueous solution of sodium alginate IL-2 produced by KIMICA Corporation (concentration: 0.3 to 0.5% by weight) or an aqueous solution of sodium alginate I-S produced by KIMICA Corporation [concentration: 0.3 to 1.5% by weight]) indicated in Table 2 was applied (printed) to the above one surface according to a direct gravure method. The application could be performed without any problem. With respect to the thus obtained cigarette papers, the total amount of sodium alginate applied was measured by the method to be described hereinafter, and the air permeability was measured by the ordinary method.

Using the obtained cigarette papers, cigarettes were prepared in the same manner as in Examples 1 to 7 and Comparative Examples 1 to 7, and the PFLB values thereof were measured. The results are also given in Table 2. In Table 2, the particulars of Comparative Example 1 are reproduced.

TABLE 2

| | | | | | | | | | | | | | Properties | |
|---|---|---|---|---|---|---|---|---|---|---|---|---|---|---|
| | First aqueous solution | | | | | | Second aqueous solution | | | | | | Air | |
| | Calcium acetate | | | Calcium lactate | | | Sodium alginate (IL-2) | | | Sodium alginate (I-S) | | | permea- | |
| | Aq. | pH | Appln. | Aq. | pH | Appln. | Aq. | pH | Appln. | Aq. | pH | Appln. | bility of | |
| | soln. | of | amt. per | soln. | of | amt. per | soln. | of | amt. per | soln. | of | amt. per | cigarette | |
| | conc. | aq. | paper | conc. | aq. | paper | conc. | aq. | WP* | conc. | aq. | paper | paper | PFLB |
| | (wt. %) | soln. | (g/m²) | (wt. %) | soln. | (g/m²) | (wt. %) | soln. | (g/m²) | (wt. %) | soln. | (g/m²) | (C.U.) | (%) |
| Comp. Ex. 1 | none | — | — | none | — | — | none | — | — | none | — | — | 35 | 100 |
| (base | | | | | | | | | | | | | | |
| wrapping | | | | | | | | | | | | | | |
| paper) | | | | | | | | | | | | | | |
| Comp. Ex. 8 | none | — | — | none | — | — | none | — | — | 1 | 6.9 | 0.32 | 31 | 95 |
| Comp. Ex. 9 | none | — | — | none | — | — | none | — | — | 1.5 | 6.9 | 0.41 | 25 | 80 |
| Example 8 | 2.2 | 7.3 | 0.54 | none | — | — | 0.3 | 7.6 | 0.13 | none | — | — | 4 | 35 |
| Example 9 | none | — | — | 2.1 | 7.2 | 0.58 | 0.5 | 7.4 | 0.23 | none | — | — | 8 | 35 |
| Example 10 | 2.2 | 7.3 | 0.54 | none | — | — | none | — | — | 0.3 | 7.2 | 0.13 | 0 | 0 |
| Example 11 | none | — | — | 2.1 | 7.2 | 0.56 | none | — | — | 0.3 | 7.2 | 0.11 | 1 | 0 |

It is apparent from the results of Table 2 that the cigarette papers produced according to the present invention, even with the application of a small amount of unacidified gellable substance, can stably exhibit a low ignition propensity.

### Examples 12 to 14 and Comparative Example 10

Each of the first aqueous solutions shown in Table 3 below (aqueous solution of calcium acetate prepared from commercially available calcium acetate monohydrate, or an aqueous solution of calcium lactate prepared from commercially available calcium lactate pentahydrate, or an aqueous solution of calcium gluconate prepared from commercially available calcium gluconate monohydrate [as a pH adjuster, commercially available potassium hydroxide was added in a concentration of 0.001% by weight to each of the aqueous solution of calcium lactate and aqueous solution of calcium gluconate]) was applied entirely to one surface of the same base wrapping paper as used in Examples 1 to 7 and Comparative Examples 1 to 7. Thereafter, a second aqueous solution (aqueous solution of sodium alginate I-S produced by KIMICA Corporation [concentration: 1.0 to 3.4% by weight]) indicated in Table 3 was applied (printed) to the above one surface according to a direct gravure method so as to form a total of 56 application areas (combustion-inhibiting areas) consisting of 7 mm-width stripes disposed with 20-mm intervals in the longitudinal direction of the base wrapping paper. The application could be performed without any problem. The periphery of each of the application areas could be clearly defined. With respect to the thus obtained cigarette papers, the total amount of sodium alginate applied was measured by the method to be described hereinafter.

Using the obtained cigarette papers, cigarettes were prepared in the same manner as in Examples 1 to 7 and Comparative Examples 1 to 7, and the PFLB values thereof were measured. The results are also given in Table 3. In Table 3, the particulars of Comparative Example 1 are reproduced.

TABLE 3

| | First aqueous solution | | | | | | | | | Second aqueous solution | | | |
|---|---|---|---|---|---|---|---|---|---|---|---|---|---|
| | Calcium acetate | | | Calcium lactate | | | Calcium gluconate | | | Sodium alginate (I-S) | | | |
| | | | Appln. | | | Appln. | | | Appln. | | | Appln. | |
| | Aq. soln. | pH of | amt. per | Aq. soln. | pH of | amt. per | Aq. soln. | pH of | amt. per | Aq. soln. | pH of | amt. per | Property |
| | conc. | aq. | paper | conc. | aq. | WP* | conc. | aq. | paper | conc. | aq. | paper | PFLB |
| | (wt. %) | soln. | (g/m²) | (wt. %) | soln. | (g/m²) | (wt. %) | soln. | (g/m²) | (wt. %) | soln. | (g/m²) | (%) |
| Comp. Ex. 1 | none | — | — | none | — | — | none | — | — | none | — | — | 100 |
| (base | | | | | | | | | | | | | |
| wrapping | | | | | | | | | | | | | |
| paper) | | | | | | | | | | | | | |
| Comp. Ex. 10 | none | — | — | none | — | | none | — | — | 3.4 | 7.4 | 2.42 | 0 |
| Example 12 | 1.2 | 7.4 | 0.19 | none | — | — | none | — | — | 1 | 6.9 | 0.36 | 0 |
| Example 13 | none | — | — | 1.7 | 7.4 | 0.21 | none | — | — | 2.2 | 7.1 | 0.62 | 0 |
| Example 14 | none | — | — | none | — | — | 1.2 | 7.5 | 0.20 | 3 | 7.3 | 1.19 | 0 |

It is apparent from the results of Table 3 that the cigarette papers produced according to the present invention, even with the application of a small amount of unacidified gellable substance, can stably exhibit a low ignition propensity.

<Measuring of the Total Amount of Sodium Alginate Applied>

The measurement was carried out without performing any of degreasing, dilute sulfuric acid treatment and deproteinization treatment in the following procedure according to “The quantitative analysis method of sodium alginate contained in food” described in “Shokuhin Eiseigaku Zasshi”, Vol. 5, pages 297 to 302 (1988).

Each of the cigarette papers having sodium alginate applied thereto (1.500 m, width 27 mm)(about 1.0 g) was cut into 5 mm squares, and heated in a hot water bath at 60° C. for 5 minutes after the addition of 40 ml of 1% by weight aqueous solution of sodium hydrogen carbonate. Thereafter, the mixture was satisfactorily agitated and centrifuged (3500 revolutions, 10 minutes; same hereinafter), thereby obtaining a supernatant liquid (extract). The same extraction was performed once more for the extraction residue, thereby obtaining a supernatant liquid (extract). Further, 20 ml of 1% by weight aqueous solution of sodium hydrogen carbonate was added to the extraction residue, and sufficiently mixed and agitated, thereby obtaining a supernatant liquid (extract). The thus obtained three extracts were combined, and a 1% by weight aqueous solution of sodium hydrogen carbonate was added thereto until the total volume became 100 ml, thereby obtaining test solutions for use.

2 ml of copper-hydrochloric acid solution (8.5 M hydrochloric acid containing 0.05% by weight of copper sulfate) and 1 ml of naphthoresorcinol solution (0.4% by weight aqueous solution of 1,3-dihydroxynaphthalene) were added to 1 ml of each of a sodium alginate standard solution (1% by weight aqueous solution of sodium hydrogen carbonate containing 0 to 0.2 mg/mL of sodium alginate) and the above test solutions. Each of the obtained mixtures was heated in a boiling water bath for 65 minutes, cooled in ice water, added with 4 ml of butyl acetate, shaken, and centrifuged.

After the centrifugation, 1 ml of each of the upper layers was recovered and diluted with 3 ml of butyl acetate. Colorimetric determination was carried out at 566 nm, and the total application amount was calculated.

As described above, in the process for producing a cigarette paper according to the present invention, a cigarette paper exhibiting a lowered ignition propensity can be stably produced without the need to acidify the second aqueous solution.

What is claimed is:

1. A process for producing a cigarette paper exhibiting a low ignition propensity, comprising applying a first aqueous solution containing divalent cations to a base wrapping paper on a whole of its one surface, and applying a second aqueous solution containing a water-soluble gellable substance capable of gelling under the action of the divalent cations to at least a part of the surface of the base wrapping paper having the first aqueous solution applied thereto to thereby cause the gellable substance to gel and thus form a combustion-inhibiting substance consisting of the gel.

2. The process according to claim 1, wherein the second aqueous solution is selectively applied to a plurality of areas spaced apart from each other on the surface of the base wrapping paper having the first aqueous solution applied thereto.

3. The process according to claim 1, wherein the second aqueous solution is applied to substantially the whole of the surface of the base wrapping paper having the first aqueous solution applied thereto.

4. The process according to claim 1, wherein the divalent cations are introduced in the first aqueous solution from a water-soluble salt selected from the group consisting of calcium acetate, calcium lactate, calcium gluconate, calcium ascorbate, calcium benzoate, calcium nitrate, calcium chloride, calcium dihydrogen phosphate, magnesium carbonate, magnesium acetate, magnesium lactate, magnesium nitrate, magnesium chloride and mixtures thereof.

5. The process according to claim 1, wherein the gellable substance is selected from the group consisting of an alginic salt or ester, pectin, gellan gum and mixtures thereof.

6. The process according to claim 1, wherein the gellable substance is applied in an amount of 0.1 to 10 g per square meter of the base wrapping paper.
